(19) United States
(12) Patent Application Publication
(10) Pub. No.: US 2009/0249115 A1
(43) Pub. Date: Oct. 1, 2009

(54) METHOD AND SYSTEM FOR DYNAMIC LINK FAILOVER MANAGEMENT

(75) Inventors: Nathan Bycroft, Waitakere (NZ); Seiichiro Satoh, Kanagawa (JP); Graham Walker, Christchurch (NZ)

Correspondence Address: ARENT FOX LLP, 1050 CONNECTICUT AVENUE, N.W., SUITE 400, WASHINGTON, DC, 20036, US

(73) Assignee: Allied Telesis Holdings Kabushiki Kaisha, Tokyo (JP)

(21) Appl. No.: 12/364,225

(22) Filed: Feb. 2, 2009

Related U.S. Application Data
(60) Provisional application No. 61/006,839, filed on Feb. 1, 2008.

(51) Int. Cl. G06F 11/00

(52) U.S. Cl. 714/4; 714/47

(57) ABSTRACT

The present invention is directed to a method and system for providing redundancy and resiliency features to network devices, such as switches and routers, that do not have built-in redundancy and resiliency features. Health-check messages are periodically transmitted over a first link that transmits network data. Upon detecting a failure of the first link, transmission of network data is switched to a second redundant link, while health check messages continue to be periodically transmitted over the first link. Upon detecting that the first link has been restored, transmission of network data is switched to the first link.

### RELATED APPLICATIONS

This application claims the benefit of U.S. Provisional Application No. 61/006,839 titled METHOD AND SYSTEM FOR DYNAMIC LINK FAILOVER MANAGEMENT filed on Feb. 1, 2008, the entirety of which is incorporated by reference herein.

### BACKGROUND OF THE INVENTION

1. Field of the Invention

The present invention is directed to a method and system for providing redundancy and resiliency features to network devices, such as switches and routers. These features allow a network device to maintain active links to another device and monitor each link for failure. If a failure occurs, the system takes remedial action and diverts the network traffic to use the remaining active links, thereby keeping the network integrity intact and traffic flowing. When the failed link has been restored, network traffic is re-directed to its original path.

2. Background of the Related Art

Existing network protocols, such as the Spanning Tree Protocol (STP), initially specified in ANSI/IEEE Standard 802.1D, 1998 Edition, the Rapid Spanning Tree Protocol (RSTP), defined in IEEE Standard 802.1w-2001, the Multiple Spanning Tree Protocol (MSTP), defined in IEEE Standard 802.1s, and Cisco's Per VLAN (Virtual Local Area Network) Spanning Tree Protocol (PVSTP), collectively referred to herein as XSTP, as well as Ethernet Protection Switching Ring (EPSR), a proprietary Allied Telesis, Inc., implementation of RFC 3619 providing resiliency specifically for network rings, and the Link Aggregation Control Protocol (LACP), defined in IEEE Standard 802.1AD, are effective for loop-prevention and assuring availability of backup paths, and are incorporated by reference herein in their entirety. Although these protocols provide the possibility of disabling redundant paths in a network to avoid loops, and automatically re-enabling them when necessary to maintain connectivity in the event of a network failure, these protocols are usually only available on high-end network devices. Although EPSR and LACP are able to recover from a link failure within a few milliseconds, a typical response time for XSTP is between 3 and 30 seconds. This delay in response to failures is due, in part, to the basics of XSTP operations, which are tied to calculating the locations of link breakage points on the basis of user-provided values that are compared to determine the best (or lowest cost) paths for data traffic.

Redundancy and resiliency are important elements in network design. One problem that exists in the art today is that there are currently no suitable methods and systems that would allow network elements that do not have built-in redundancy and resiliency features to deliver similar levels of redundancy and resiliency, characteristic of high-end devices with built-in redundancy and resiliency features. In addition, there are currently no suitable methods and systems that provide failover management of redundant links and loop-free forwarding between devices with multiple connected LAN segments, using a simple control protocol on network devices that are not compatible with LACP or EPSR. Further, there are currently no suitable methods and systems that provide effective, cost-efficient and faster alternatives to the xSTP protocols, without the accompanying protocol complexity and increased hardware cost, Moreover, there are currently no suitable methods and systems that provide load sharing capabilities on network devices that are not compatible with the LACP protocols (e.g., various routers).

Thus, there is a need in the art to provide redundancy and resiliency features to networking devices that do not have built in redundancy and resilience features.

### SUMMARY OF THE PRESENT INVENTION

Aspects of the present invention address the above identified needs, as well as others, by providing methods and systems for allowing network elements that do not have built-in redundancy and resiliency features to deliver similar levels of redundancy and resiliency, characteristic of high-end devices with built-in redundancy and resiliency features. In addition, aspects of the present invention provide methods and systems for failover management of redundant links and loop-free forwarding between devices with multiple connected LAN segments, using a simple control protocol on network devices that are not compatible with XSTP, EPSR or LACP. Further, aspects of the present invention provide methods and systems for effective, cost-efficient and faster alternatives to the XSTP protocols, without the accompanying protocol complexity and increased hardware cost. Moreover, aspects of the present invention provide methods and systems that deliver load sharing capabilities on network devices that are not compatible with the LACP protocol (e.g., various routers).

Additional advantages and novel features will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary flowchart of a method for dynamic link failover, in accordance with an aspect of the present invention;

FIG. 2 illustrates an exemplary system diagram showing a healthy primary link, in accordance with an aspect of the present invention;

FIG. 3 illustrates an exemplary system diagram showing a failover condition, in accordance with an aspect of the present invention;

FIG. 4 illustrates an exemplary system diagram showing a recovery condition, in accordance with an aspect of the present invention;

FIG. 5 illustrates an exemplary system diagram showing a load sharing mechanism, in accordance with an aspect of the present invention;

FIG. 6 presents an exemplary system diagram of various hardware components and other features, for use in accordance with an aspect of the present invention; and

FIG. 7 is a block diagram of various exemplary system components, in accordance with an aspect of the present invention.

### DESCRIPTION OF THE INVENTION

Aspects of the present invention enable mimicking high-end features on low-end products, or products without built-in resilience and redundancy features, using generation and monitoring of health-check data. Health-check data may include monitoring the status of a data link or data path by sending health check packets. The health-check mechanisms may use ping-poll and trigger scripting features that are available, for example, in Allied Telesis, Inc. network devices, such as switches and routers running AW 1.6.1 and AW+5.2.1 and subsequent releases, for monitoring health-check data (see, e.g., www.alliedtelesyn.com, as viewed on Dec. 18, 2008, which is incorporated in its entirety by reference herein).

In accordance with one aspect, there may be two data links, a primary link and a secondary link. In addition, there may be a health-check virtual local area network (VLAN) which may be configured on the two data links, but is logically separate from the data links.

In accordance with one aspect, when a remote device becomes unreachable over the health-check VLAN, the data VLANs are removed from the primary link and added to the secondary link, so that traffic is restored across these VLANs. When the health-check mechanism detects that the remote device is reachable again via the primary link, a network loop has been prevented because traffic can only flow across the data VLAN which has been moved to the secondary link. To restore traffic on the primary link, the data VLANs are removed from the secondary link and added back to the primary link, i.e., the previous change is reversed. In this way, minimal disruption occurs, in accordance with this aspect, to services across the data VLANs when failover occurs, and no network loops are able to form.

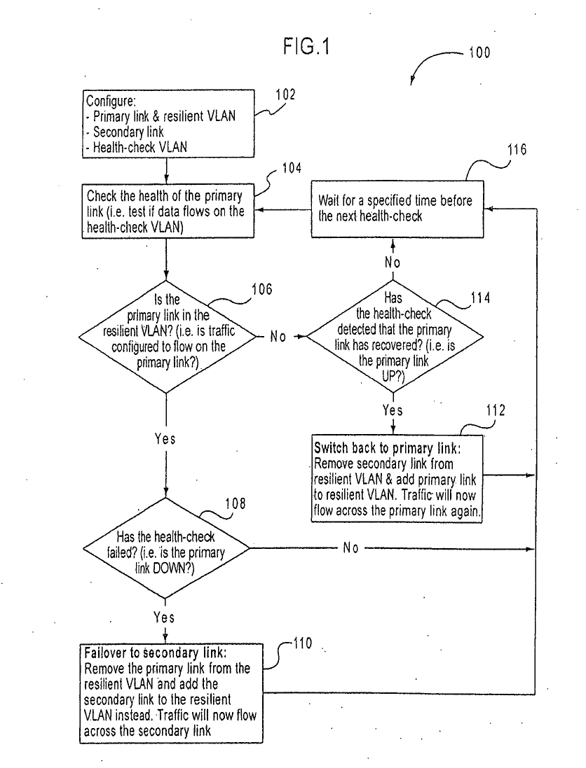

FIG. 1 illustrates an exemplary flow diagram 100 of functions performed for failover management of redundant virtual local area network (VLAN) links on a network switch, thereby preventing data (e.g., packets or frames) being sent via the VLAN from looping around the VLAN indefinitely through redundant links, in accordance with an aspect of the present invention.

In step 102, primary and secondary links may be configured among networking devices. A standard configuration script may be used, or the configuration may occur at the command line, among other configurations. In an aspect, the primary link may be used as the main link for transferring data while the secondary link may be a back-up link to the primary link. In addition, there may be two groups of data flowing across the primary link, network user data and health check data.

According to an aspect of the present invention, the primary link and the health-check VLAN may be configured to flow over the same data port. However, the health check VLAN may be logically separate from the traffic paths (e.g., the primary and secondary links), since the traffic paths and the health-check VLAN are using different VLANs. In one aspect, a health-check VLAN is uniquely associated with a primary link, so that failure and recovery of the primary link may be detected.

The health of the primary link may be checked by periodically sending a health-check packet and/or message over the health-check VLAN to test whether data is flowing over the primary link 104. Sending a health-check packet may be done using standard networking protocols. For example, a health-check data item (e.g., an Internet Control Message Protocol (ICMP) ping packet) may be used as the control protocol to detect the state of the primary path, also referred to throughout as primary link. It should be appreciated that the health of any networking device may be checked.

If, in reply to the health-check message, the other networking device returns a response, the primary link may be considered in good condition, since the primary link is up and responding to the health-check message 108. The data may continue to flow over the primary link until a subsequent periodic health-check message indicates that the primary has failed. The state of the primary link may be checked at periodic configurable intervals 116. For example, the health check signals may be transmitted every second or every two seconds, among other time periods. Thus, the data may continue to flow on the primary link while the health-check VLAN periodically checks the health of primary link.

If, in reply to the health-check message, the other networking device does not return a message, the primary link may be considered to have failed. For example, the primary link may be down with no traffic flowing across the primary link. When the health of the primary link fails, a failover to the secondary link may occur 110. For example, upon detecting a failure of a primary network path, a redundant secondary network path is activated. Thus, the data traffic may be removed from the primary link and redirected to flow on the secondary link. This may be achieved by reconfiguring the VLAN to operate on the secondary link instead of the primary link. The data traffic may flow over the secondary link, until a subsequent health-check message indicates the primary link has recovered.

While the data is flowing over the secondary link, it should be appreciated that the health check VLAN may monitor the status of the primary link by continuing to transmit health-check messages (e.g., steps 104 and 116), even if the primary link is down and network data is flowing on the secondary link. A determination whether the traffic is flowing over the primary link may occur at step 106. If the data traffic is flowing over the secondary link, instead of the primary link, a check occurs to determine whether the health check has detected that the primary link has recovered 114. If the primary link has not recovered, then the data traffic continues to flow on the secondary link until a subsequent health-check message 104 and 116 indicates the primary link has recovered.

However, if a detection indicates that the primary link has been recovered, the data traffic may be transferred back to the primary link by reconfiguring the VLAN to allow network data to flow on the primary link, instead of the secondary link 112. The detection may include receiving a response in reply to the health-check message 104, for example. Further, the secondary link may be closed to the forwarding of data traffic, thereby preventing a network loop. Once the data traffic is flowing on the primary link, the process repeats steps 116 and 104 by checking the health of the primary link. In accordance with one aspect, multiple instances of the method of the present invention may provide load sharing of data using segregated VLANs over different links.

In accordance with one aspect, the method of the present invention utilizes a combination of changing switchport VLAN assignments to control traffic flow and the network device ping-polling and trigger features.

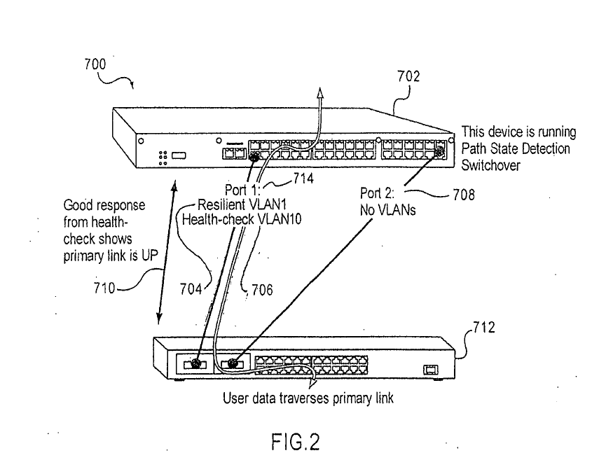

In one aspect, only one of the networking devices may use the method of the present invention, as illustrated in FIGS. 2-5, while the other device simply responds to the health-check message sent. However, in another aspect, both networking devices in communication which each other may use the method of the present invention.

Referring now to FIG. 2, therein illustrated is an exemplary system 700 using a healthy primary link and running Path State Detection Switchover, in accordance with an aspect of the present invention. Path State Detection Switchover may be used to monitor the status of the primary link and to switch over to the secondary link if a failure on the primary link occurs. As illustrated in FIG. 2, a first networking device 702 may have multiple ports for data transfer. For example, networking device 702 may have port1 714 and port2 708 . Port1 714 may be a primary link and port2 708 may be a back-up secondary link. It should be appreciated that the primary and secondary link may be configured, respectively, (e.g., step 102 in FIG. 1) from any port on a networking device. In addition, port1 714 and port2 708 may be communicating with ports on a second networking device 712 allowing data to transfer between networking device 702 and networking device 712.

The data traffic on resilient VLAN1 704 and the health-check VLAN10 706 may be configured to flow on primary link 714. Health check packets checking the health of primary link 714 may be sent over health-check VLAN10 706. The second networking device 712 may respond to the heath-check packets, thus the health of primary link 714 may be considered good 710. Therefore, since the health of the primary link 714 is good, the data continues to flow over VLAN1 704 on primary link 714. Thus, in this aspect, no data is flowing over secondary link 708.

It should be appreciated it might be more beneficial for the data to continue to flow over primary link 714 instead of secondary link 708. For example, secondary link 708 may be more expensive to use (e.g., a dial-up link, using expensive leased equipment, among others), or secondary link 708 may have a lower bandwidth with lower traffic throughput, among other disadvantages. Thus, secondary link 708 may be beneficial for use in emergency situations, e.g., when primary link 714 fails, not for regular data communications.

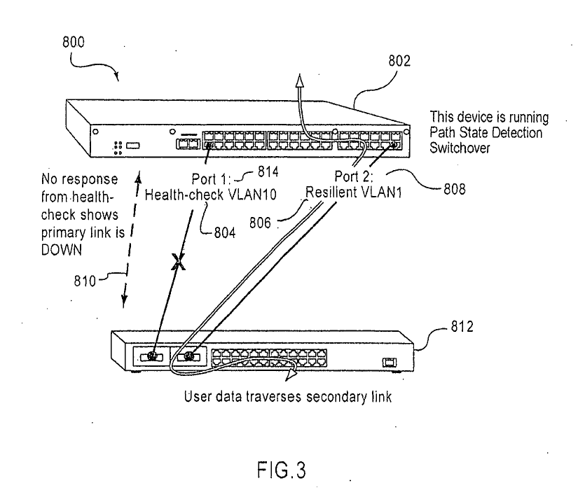

Referring now to FIG. 3, therein illustrated is an exemplary system 800 using a failover condition, in accordance with an aspect of the present invention. As discussed above in reference to FIG. 2, networking device 802 may have a primary link port1 814 and a secondary link port2 808. In addition, primary link 814 may have a health-check VLAN10 804 checking the health of primary link 814. However, in this aspect, networking device 812, which is communicating with networking device 802, is not responding to the health-check packets being sent on health-check VLAN10 804. Thus, primary link 814 may be considered to have failed, triggering the need for a failover to secondary link 808. Therefore, data traffic on resilient VLAN1 806 may be configured to flow on secondary link 808, instead of on primary link 814, by removing VLAN1 806 from primary link 814 and transferring VLAN1 806 to secondary link 808.

While data traffic on resilient VLAN1 806 is flowing on secondary link 808, health check packets may continue to be sent over health-check VLAN10 804 checking the health of primary link 814. It should be appreciated that the network user may not notice a disruption in network traffic, even though primary link 814 has failed. Since the failover to secondary link 808 occurs almost instantaneously, the data traffic may continue to flow with little or no interruption.

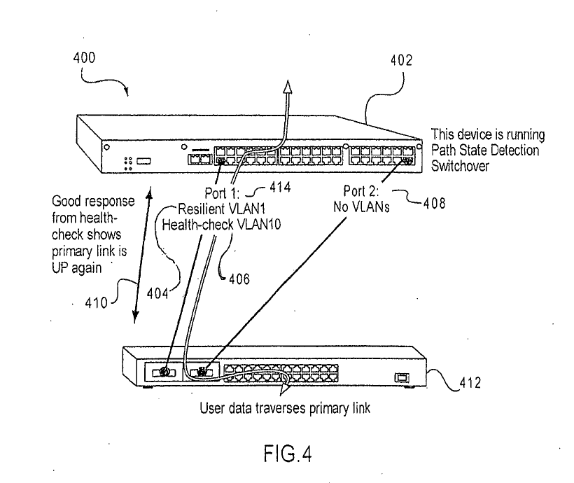

Turning now to FIG. 4, therein illustrated is an exemplary system diagram 400 using a recovery condition, in accordance with an aspect of the present invention. Networking device 402 may have a primary link port1 414, a secondary link port2 408, and a health-check VLAN10 406, among other features. Further, networking device 412 may be communicating with networking device 402 via primary link 414 and secondary link 408. In this aspect, networking device 412 may return a response to health-check packets, indicating that primary link 414 may have recovered 410.

The data traffic on resilient VLAN1 404 may be reconfigured to flow on primary link 414 instead of secondary link 408 by removing VLAN1 404 from secondary link 408 and transferring VLAN1 404 to the primary link 414. In an aspect, an automated mechanism may be used to transfer VLAN1 404 from secondary link 408 to primary link 414. Secondary link 408 may become the back-up link again without network data flowing over secondary link 408. Thus, once the recovery is complete, both the data traffic on resilient VLAN1 404 and health-check VLAN10 406 are flowing on the primary link 414.

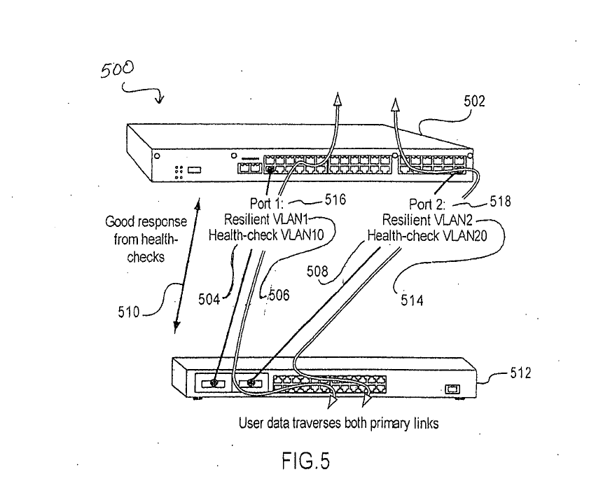

In accordance with another aspect, multiple instances of “health-check VLANs” may be configured to monitor alternate links, as illustrated in FIG. 5. The data VLANs may be distributed across multiple connected LAN segments, so that load sharing occurs when all links are up and operating. As illustrated in the exemplary system diagram 500 in FIG. 5, a first link port1 516 may be the primary link for data VLAN1 506 and the secondary link for data VLAN2 514, and a second link port2 518 may be the primary link for data VLAN2 514 and the secondary link for data VLAN1 506. Both links 516 and 518 may have health-check VLAN10 504 and health-check VLAN20 508, respectively, running health-checks on the respective links 516 and 518.

Data traffic on data VLAN1 506 and data VLAN2 514 may be forwarded across both links 516 and 518. If either link 516 or 518 fails, the data traffic from the failed link may be routed to the other link. It should be appreciated that failover and recover situations may be handled in the same manner as discussed above in regard to FIGS. 1-4. Furthermore, it should be appreciated that links 516 and 518 may have equivalent bandwidths and equivalent costs. Thus, the load of the network may be spread across both links without incurring extra cost or loss of performance. In addition, using two links may double the bandwidth, allowing more throughput of traffic across the networking device.

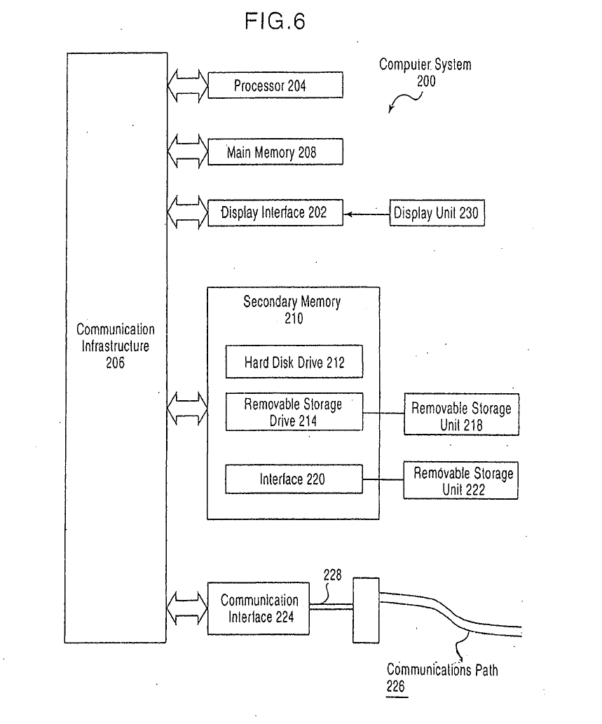

Aspects of the present invention may be implemented using hardware, software, or a combination thereof and may be implemented in one or more computer systems or other processing systems. In one aspect, the invention is directed toward one or more computer systems capable of carrying out the functionality described herein. An example of such a computer system 200 is shown in FIG. 6.

Computer system 200 includes one or more processors, such as processor 204. The processor 204 is connected to a communication infrastructure 206 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage unit 218, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

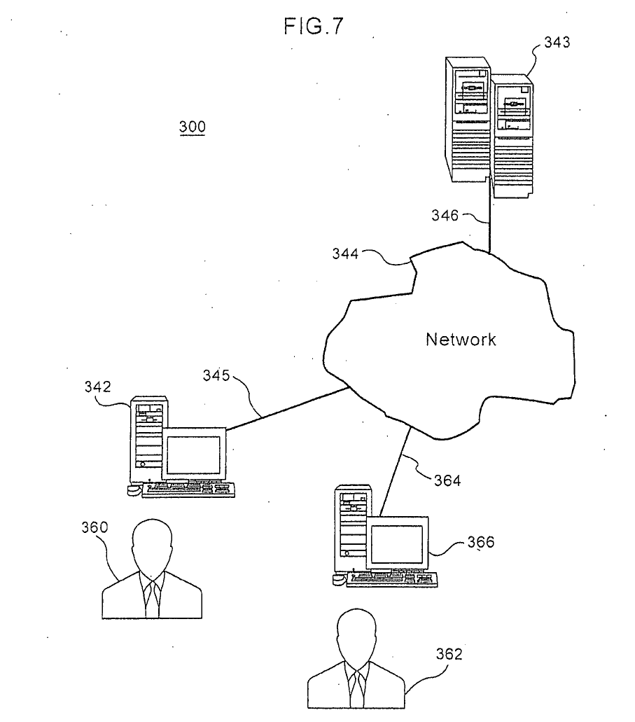

FIG. 7 shows a communication system 300 usable in accordance with aspects of the present invention. The communication system 300 includes one or more accessors 360, 362 (also referred to interchangeably herein as one or more “users”) and one or more terminals 342, 366. In one aspect, data for use in accordance with aspects of the present invention is, for example, input and/or accessed by accessors 360, 362 via terminals 342, 366, such as personal computers (PCs), minicomputers, mainframe computers, microcomputers, telephonic devices, or wireless devices, such as personal digital assistants (“PDAs”) or a hand-held wireless devices coupled to a server 343, such as a PC, minicomputer, mainframe computer, microcomputer, or other device having a processor and a repository for data and/or connection to a repository for data, via, for example, a network 344, such as the Internet or an intranet, and couplings 345, 346, 364. The couplings 345, 346, 364 include, for example, wired, wireless, or fiberoptic links. In another aspect, the method and system of the present invention operate in a stand-alone environment, such as on a single terminal.

While the present invention has been described in connection with preferred aspects, it will be understood by those skilled in the art that variations and modifications of the preferred aspects described above may be made without departing from the scope of the invention. Other aspects will be apparent to those skilled in the art from a consideration of the description or from a practice of the invention disclosed herein.

What is claimed is:

1. A method for performing link failover management on a network device, the method comprising:
configuring a plurality of links on the network device, wherein the plurality of links include a primary link and a secondary link;
checking a state of the primary link via the health check message;
upon determining that the state of the primary link has failed, triggering the transfer of data traffic from the primary link to the secondary link; and
transmitting data traffic on the secondary link until receipt of a message indicating that the state of the primary link has recovered.

2. The method of claim 1, further comprising:
transferring the data traffic from the secondary link to the primary link upon receipt of the message indicating that the state of the primary link has recovered.

3. The method of claim 1, wherein checking the state of the primary link includes sending a ping message.

4. The method of claim 1, wherein the health check message is transmitted over a VLAN that is logically separate from the first link and the second link.

5. The method of claim 1, further comprising:
checking the state of the primary link via the primary link while the data traffic is on the secondary link.

6. The method of claim 1, wherein the checking is performed every second.

7. A system for performing link failover management on a network device, the system comprising:
a configuring means for configuring a plurality of links on the network device, wherein the plurality of links include a primary link and a secondary link;
a checking means for checking a state of the primary link via a health check message;
a determining means for triggering the transfer of data traffic from the primary link to the secondary link, upon determining that the state of the primary link has failed; and
a transmitting means for transmitting data traffic on the secondary link until receipt of a message indicating that the state of the primary link has recovered.

8. The system of claim 7, further comprising:
means for transferring the data traffic from the secondary link to the primary link upon receipt of the message indicating that the state of the primary link has recovered.

9. The system of claim 7, wherein checking the state of the primary link includes sending a ping message.

10. The system of claim 7, wherein the health check message is transmitted over a VLAN that is logically separate from the first link and the second link.

11. The system of claim 7, further comprising:
means for checking the state of the primary link via the primary link while the data traffic is on the secondary link.

12. The system of claim 7, wherein the checking is performed every second.

13. A system for performing link failover management on a network device, the system comprising:
a processor;
a user interface functioning via the processor; and
a repository accessible by the processor;
wherein a plurality of links are configured on the network device, the plurality of links including a primary link and a secondary link;
wherein a state of the primary link is checked via a health check message;
wherein data traffic is transferred from the primary link to the secondary link, upon determining that the state of the primary link has failed; and
wherein data traffic is transmitted on the secondary link until message is received indicating that the state of the primary link has recovered.

14. The system of claim 13, wherein the processor is housed on a server.

15. The system of claim 14, wherein the server is coupled to a network.

16. The system of claim 13, wherein the coupling is selected from a group consisting of a wired connection, a wireless connection, and a fiberoptic connection.

17. The system of claim 13, wherein the repository is housed on a server.

18. The system of claim 17, wherein the server is coupled to a network.

19. A computer program product comprising a computer usable medium having control logic stored therein for causing a computer to performing link failover management on a network device, the control logic comprising:
first computer readable program code means for configuring a plurality of links on the network device, wherein the plurality of links include a primary link and a secondary link;
second computer readable program code means for checking a state of the primary link via a health check message;
third computer readable program code means for triggering the transfer of data traffic from the primary link to the secondary link, upon determining that the state of the primary link has failed; and
fourth computer readable program code means for transmitting data traffic on the secondary link until receipt of a message indicating that the state of the primary link has recovered.
